(19) United States
(12) Patent Application Publication
(10) Pub. No.: US 2014/0268757 A1
(43) Pub. Date: Sep. 18, 2014

(54) Room dividing lighting device and method of installing the room dividing lighting device

(71) Applicant: KONINKLIJKE PHILIPS N.V., Eindhoven (NL)

(72) Inventors: Michel Cornelis Josephus Marie Vissenberg, Roermond (NL); Christopher Paul Paul Schutte, Milan (NL); Michiel Adriaanszoon Klompenhouwer, Waalre (NL)

(73) Assignee: KONINKLIJKE PHILIPS N.V., Eindhoven (NL)

(21) Appl. No.: 14/357,372

(22) PCT Filed: Nov. 6, 2012
(86) PCT No.: PCT/IB2012/056187

§ 371 Date: May 9, 2014

Related U.S. Application Data
(60) Provisional application No. 61/558,501, filed on Nov. 11, 2011.

(51) Int. Cl. F21S 8/00

(52) U.S. Cl. CPC F21S 8/00
USPC 362/235; 29/592

(57) ABSTRACT

A room dividing lighting device 120, 122, the use of the room dividing lighting device and a method of installing the room dividing lighting device are provided. The room dividing lighting device 120, 122 comprises a light emitting means. The room dividing lighting device 120, 122 is used for separating a subspace 104 from a space 102 to prevent a person 114, 118 from coming close to or entering the subspace 104 in a privacy operational mode of the room dividing lighting device 120, 122. The light emitting means emits light in an upward direction and is configured to emit, in a privacy operational mode, glary light in a light beam 108 for hindering the person 114, 118 who enters the light beam 108 or crosses it with his eyes 112, 116. The light emitting means comprises at least one light source and a light redirection means. The light redirection means receives light from the at least one light source and is configured to redirect, at least in the privacy operational mode, the received light in the light beam 108.

### FIELD OF THE INVENTION

The invention relates to a room dividing lighting device for separating a subspace from a space.

### BACKGROUND OF THE INVENTION

Often, in offices, a relatively large number of people are working in a single room. Especially, in open-plan offices it is relatively difficult to prevent disturbance of people by other people present in the same open-plan office. Traditionally, cubicle separation walls are arranged around desks of people who do not want to be disturbed or require a certain amount of privacy.

Published patent application US20100177533 discloses privacy panels which may be used to obtain privacy for a person who is located behind the privacy panel. In specific embodiments of the privacy panel, the privacy panel is a transparent plate which is positioned between a person who needs privacy and other people. The transparent plate comprises light sources arranged at least at one edge of the transparent plate and the light sources emit, if they are in operation, light into the transparent plate. The transparent plate guides the light through the plate and, at a plurality of positions at one of the surfaces of the transparent plate, light outcoupling structures are arranged which redirect guided light away from the person towards the other people. If the light sources are in operation, the other people receive a relatively large amount of light from the transparent plate and the other people experience the transmitting plate as a light emitting surface. The other people cannot see what happens behind the transparent plate, because the light that is emitted by the transparent plate towards the other people is relatively intense compared to light that is transmitted from the position of the person through the transparent plate towards the other people. Thus, the person obtains privacy. If the light sources are not in operation, no additional light is outcoupled and only the normal environmental light is emitted into two directions through the light transmitting plate and all persons in the office are able to see each other.

The privacy panels provide privacy to the person behind the privacy panel. However, when the privacy panel is in operation, the other people experience the office as a smaller office because the privacy panel seems to be a non-transparent wall. Especially, when the person who is surrounded by the privacy panels is located in the center of the office, the office seems to be subdivided into much smaller rooms when the privacy panel is in operation.

Privacy does not necessarily mean that the line of sight between people in the office has to be blocked. Often, in open plan offices, the person, who wants to have some privacy only doesn't want to be disturbed, which means that other people should not come close to him or approach him. For the person who wants to have some privacy, often it is not a problem if he is able to see the other people and if the other people are able to see him, as long as he is not disturbed by them. Further, in order to work effectively and efficiently and to stimulate collaboration, a free line of sight between all employees in an office is advantageous.

### SUMMARY OF THE INVENTION

It is an object of the invention to provide a room dividing lighting device which prevents or discourages people from coming close to a specific person who doesn't want to be disturbed, while at the same time, people who are not close to the specific person have a clear view throughout the space in which the specific person and the people are present.

A first aspect of the invention provides a room dividing lighting device. A second aspect of the invention provides the use of the room dividing lighting device. A third aspect of the invention provides a method of installing a room dividing lighting device. Advantageous embodiments are defined in the dependent claims.

A room dividing lighting device in accordance with the first aspect of the invention comprises a light emitting means. The room dividing lighting device is intended for separating a subspace from a space to prevent a person from coming close to or entering the subspace in a privacy operational mode of the room dividing lighting device. The light emitting means emits light in an upward direction and is configured to emit, in a privacy operational mode, glary light in a light beam for hindering the person who enters the light beam or crosses it with his eyes. The light emitting means comprises at least one light source and a light redirection means. The light redirection means receives light from the at least one light source and is configured to redirect, at least in the privacy operational mode, the received light into the light beam.

The room dividing lighting device emits glary light in an upward direction, which means that the eyes of a person walking towards the subspace enter the light beam at a specific location. The person experiences the glary light as unpleasant light and he will return to a specific position outside the light beam. Thus, the glary light forms a barrier for people, dissuading them to cross said virtual line or enter said virtual area. Therefore, a person who is in the subspace will not be disturbed by other persons. Further, because the separation is obtained by means of light, there is no (optical) barrier for people who are not in a position where their eyes are within the light beam. Thus, the room dividing lighting device does not block the line of sight between people present in the office.

The room dividing lighting device emits light in an upward direction, which means that the light is emitted towards the ceiling of the space. It is to be noted that the upward direction is not by definition exactly parallel to a normal to the surface of the earth. An upward direction is at least a direction parallel to a vector which starts at a first point and ends at a second point that is farther away from the earth surface than the first point. The light is emitted towards the ceiling, and, as long as the ceiling does not fully absorb the impinging light, at least a portion of the light is reflected to light the space. The light is possibly diffusely reflected by the ceiling, which results in diffuse lighting of the space, which is, for example, preferred in an office. Thus, the room dividing lighting device has the additional advantageous effect of lighting the space.

Glary light results in glare, which means that the person who looks into the light beam has difficulty seeing, or, it means that the eyes of the person who looks into the light beam receive more light than an amount of light to which the eyes of the person are accustomed. This is an unpleasant, disturbing experience for the person and, therefore, the person will try not to look into the light beam to stop the effect of glare. In general, glare is experienced when a high light intensity is emitted by a relatively small light emission surface. It is to be noted that glare is a disturbing or unpleasant brightness. Brightness is a perceptual quality related to luminance. Luminance is the amount of light radiated by a visible light emitting surface in a certain direction. Thus, glare is related to the luminance of the light in the light beam and the contrast with the ambient lighting conditions.

The light beam with the glary light is not necessarily a very narrow light beam. A maximum light emission angle with respect to a central axis of the light beam may be more than 20 degrees, and may even be more than 30 degrees, however, the width of the light beam should be limited such that the glary light is not directly emitted towards the person in the subspace who does not want to be disturbed, and such that the glary light is not emitted too far beyond a border of the subspace towards the eyes of persons far enough away from the border.

The light beam does not necessarily comprise glary light at every light emission angle. At least at light emission angles smaller than 20 degrees with respect to the central axis the light beam comprises glary light.

Optionally, the maximum light emission angle with respect to the central axis of the light beam is smaller than 45 degrees.

Optionally, the average luminance of the light beam is larger than 10.000 Cd/m². Luminance is the amount of light radiated by a visible light emitting surface in a certain direction. The visible light emitting surface may be the emitting surface of the light source, if the light emitting surface is directly visible if a person looks into the light beam and if the light redirection means does not enlarge or reduce the light emitting surface. The visible light emitting surface may also be the sum of certain surfaces of the light redirection means which emit the light of the light beam. The visible light emitting surface may also be a combination of the above options and may be enlarged and/or reduced by certain optics used in the light redirection means. An average luminance is the average of luminances of light emission directions of the light beam. Thus, if the average luminance is larger than 10.000 Cd/m², there are a number of light emission directions within the light beam in which the luminance is significantly larger than 10.000 Cd/m². A majority of the people considers a luminance of more than 10.000 Cd/m² as glary light and experience the light as unpleasant light.

Optionally, the average luminance of the light beam is larger than 30.000 Cd/m². Not all people are too bothered about a luminance of 10.000 Cd/m², especially if the office in which the light beam is emitted is brightly lit. A luminance larger than 30.000 Cd/m² is even in this condition experienced by humans as glary light. In an embodiment, the maximum luminance of light of the light beam is smaller than 200.000 Cd/m².

Optionally, the room dividing lighting device comprises a base for supporting the light emitting means. The height of the base is configured so as not to obstruct a direct line of sight between people who are present in the space and who sit on a chair or who stay upright. Thus, the base does not prevent the people in the room from seeing each other, as long as they are not in a position where their eyes are within the glary light of the light beam, and, thus, collaboration between the people is not limited by the base.

Optionally, the height of the base is lower than 1.3 meter. Optionally, the height of the base is lower than 1 meter.

Optionally, the light direction means comprises a transparent light guiding structure. The transparent light guiding structure receives light from the at least one light source. The transparent light guiding structure comprises light outcoupling structures to outcouple light being guided within the transparent light guiding structure in the upward direction. The transparent light guiding structure may be arranged in a line of sight between people who sit or who stay upright in the space. The view between the people is not obstructed, because the transparent light guiding structure is transparent and, consequently, the people can look through the transparent light guiding structure. The outcoupling structures outcouple light such that the upwards directed light beam with glary light is obtained. Thus, if a person comes too close to the transparent light guiding structure, his eyes receive the glary light and the person will not continue in the direction of the subspace; instead he will move back such that his eyes do not receive the glary light anymore.

The height of the transparent light guiding structure, thus, is not limited by the line of sight between the people present in the space. Consequently, the transparent light guiding structure may have such a height that disturbing sound is partly blocked to prevent disturbance of the person present in the subspace.

Optionally, the light outcoupling structures are recesses and/or protrusions in a light emitting surface of the transparent light guiding structures. Optionally, the recesses and/or protrusions comprise transparent facets. A facet is a flat surface of the recess and/or protrusion.

Optionally, the light redirection means is a lens, a collimator or a reflector. These optional light redirection means are relatively cheap to manufacture and are relatively small.

Optionally, the room dividing lighting device is further configured to operate in a non-privacy operational mode for not separating the subspace from the space. Thus, if the person does not want to have the amount of privacy provided by the room dividing lighting device in the privacy operational mode, the other operational mode may be activated. This may be done by a user, who selects the operational mode, or the room dividing lighting device automatically detects whether it is desired to operate the room dividing lighting device in the privacy or non-privacy operational mode. This automatic detection may, for example, detect whether a person is working in the sub-space (for example, by means of a presence/movement sensor, or by sensing the activity of a personal computer present in the sub-space).

Optionally, the light emitting means is configured for emitting, in the non-privacy operational mode, the light beam in another direction which does not cross the path of the eyes of the person who comes close to or who tries to enter the subspace. Thus, glary light is still emitted, however, this emitted glary light is not seen by the person who approaches the subspace or comes close to the subspace. According to this option, light is still emitted in the upward direction and, consequently, the light may be reflected by the ceiling of the space. Consequently, in the non-privacy operational mode, the room dividing lighting device also acts as a lighting system for the space.

Optionally, the light emitting means is further configured to emit, in the non-privacy operational mode, non-glary light in an upward direction. If non-glary light is emitted in the upward direction, a person who is in a position where his eyes are within a light beam of non-glary light does not experience the light as unpleasant light, and thus, the person will enter the subspace or come close to the subspace. According to this advantageous option, the room dividing lighting device still emits light in the upward direction when it is operated in the non-privacy operational mode and therefore the room dividing lighting device still has the additional function of a lighting system for the space.

Optionally, the light sources of the light emitting means are configured to emit, in the non-privacy operational mode, light at a reduced flux compared to the privacy operational mode. Reducing the flux is an effective way of reducing the effect of glare. It further saves energy. Flux is the total light output of the light sources.

Optionally, the light emitting means emits, in the non-privacy operational mode, light along a first light emitting surface, and emits, in the privacy operational mode, light along a second light emitting surface. The second light emitting surface is smaller than the first light emitting surface. If the same flux is emitted along a larger light emitting surface, the luminance of the light is reduced. If the luminance is lower, the effect of glare is reduced.

Optionally, in the non-privacy operational mode more light sources emit light than in the privacy operational mode, and in the non-privacy operational mode the larger number of light sources, individually, emit less light than the light sources which emit light in the privacy operational mode. This again lowers the luminance.

Optionally, the light emitting means is configured to emit, in the non-privacy operational mode, a wider light beam than the light beam emitted in the privacy operational mode. Using the same flux and the same light emitting area, this results in a lower light source luminance and, hence, less glare.

Optionally, the lens, the collimator or the reflector have a first relative position with respect to one or more light sources that emit light in the privacy operational mode, and the lens, the collimator or the reflector have a second relative position with respect to one or more light sources that emit light in the non-privacy operational mode. The first relative position is different from the second relative position. The width of the light beam changes when the lens, the collimator, or the reflector is moved relative to the light sources. It is also possible to switch on different groups of light sources which have a different relative position, such that other light beam shapes are obtained. These optional features are effective, efficient and may be realized at relatively low costs.

Optionally, the room dividing lighting device further comprises a sound masking device or a sound cancellation device for reducing, in the privacy operational mode, distraction by sound originating from positions outside the subspace. As discussed before, the room dividing lighting device provides no sound blocking or absorption, or provides said sound blocking or absorption only to a limited extent. If a person present in a subspace of an office does not want to be disturbed, it would be advantageous if he is not disturbed by, for example, conversations between his colleagues. Sound cancellation devices can locally reduce the intensity of specific sounds. Sound masking devices transmit white noise and if this white noise is transmitted into the subspace, the white noise masks the sounds coming from outside the subspace. People are not disturbed by the white noise because the mind (partly) ignores the sound of white noise.

Optionally, a desk is provided. The desk comprises at least one room dividing lighting device for emitting a glary light beam in an upward direction in a privacy operational mode of the room dividing lighting device. The room dividing lighting device is arranged at an edge of the desk.

Optionally, a method of separating a subspace from a space is provided. The method prevents that people come close to or enter into the subspace, and the method comprises the step of emitting, in a privacy operational mode, glary light in a light beam in an upward direction. The glary light is emitted by a light emitting means. The emitted light beam crosses a path of the eyes of a person who tries to come close to or enter into the subspace. The light emitting means comprises i) at least one light source, and ii) a light redirection means that receives light from the at least one light source and redirects, in the privacy operational mode, the received light into the light beam.

According to a second aspect of the invention, use of a room dividing lighting device according to the first aspect of the invention is provided. The room dividing lighting device is used for separating a subspace from a space.

According to a third aspect of the invention, a method of installing a room dividing lighting device is provided. The method of installing the room dividing lighting device in a space is provided for separating the subspace from the space if the room dividing lighting device operates in a privacy operational mode. The method comprises the steps of i) providing a room dividing lighting device, the room dividing lighting device comprising a light emitting means for emitting light in an upward direction and being configured to emit, in a privacy operational mode, glary light in a light beam for hindering any person entering the light beam or crossing it with his eyes, the light emitting means comprising at least one light source and a light redirection means receiving light from the at least one light source and being configured for redirecting, at least in the privacy operational mode, the received light into the light beam, ii) installing the room dividing lighting device on or close to a border of the subspace to obtain the light beam in the upward direction on or close to the border of the subspace.

The use of the room dividing lighting device and the method of installing the room dividing lighting device provide the same benefits as the room dividing lighting device according to the first aspect of the invention and have similar embodiments with similar effects as the corresponding embodiments of the system.

These and other aspects of the invention are apparent from and will be elucidated with reference to the embodiments described hereinafter.

It will be appreciated by those skilled in the art that two or more of the above-mentioned options, implementations, and/or aspects of the invention may be combined in any way deemed useful.

Modifications and variations of the room dividing lighting device and/or the method, which correspond to the described modifications and variations of the room dividing lighting device, can be carried out by a person skilled in the art on the basis of the present description.

### BRIEF DESCRIPTION OF THE DRAWINGS

In the drawings:

FIGS. 1a and 1b schematically show the use of the room dividing lighting device according to the first aspect of the invention in a privacy operational mode,

FIGS. 2a and 2b schematically show two embodiments of the use of the room dividing lighting device in a non-privacy operational mode,

FIG. 3 schematically presents an alternative embodiment of the room dividing lighting device,

FIGS. 4a and 4b schematically show a cross-section of two embodiments of a room dividing lighting device,

FIGS. 5a and 5b schematically show cross-sections of two other embodiments of a room dividing lighting device comprising a collimator,

FIG. 6a schematically shows a cross-section of an embodiment of a room dividing lighting device which emits light along a larger surface in a non-privacy operational mode,

FIG. 6b schematically shows a three dimensional view of the embodiment of FIG. 6a,

FIGS. 7a and 7b schematically show two embodiments of a room dividing lighting device comprising a transparent light guiding structure, and

FIGS. 8 to 10 present angular light emission profiles of room dividing lighting devices comprising a transparent light guiding structure.

It should be noted that items denoted by the same reference numerals in different Figures have the same structural features and the same functions, or are the same signals. Where the function and/or structure of such an item have been explained, there is no necessity for repeated explanation thereof in the detailed description.

The Figures are purely diagrammatic and not drawn to scale. Particularly for clarity, some dimensions are exaggerated strongly.

### DETAILED DESCRIPTION

FIGS. 1a and 1b schematically show the use of the room dividing lighting device 120, 122 according to the first aspect of the invention in a privacy operational mode. Space 102 is, for example, an open plan office. In the space 102, a first person 106 sits at his desk 121 and he does not want to be disturbed because he has to concentrate on his work. So, the first person 106 wants a sort of subspace 104 around his desk which is, in a way, separated from the space 102. The first person 106 does not want the second person 114 and the third person 118 to come too close to his desk, which means that he does not want that the second person 114 and the third person 118 enter the subspace. If the other persons 114, 118 do not come too close, he is not distracted by their presence and it is more difficult for the second person 114 and the third person 118 to start a conversation with the first person 106. According to the first aspect of the invention, a room dividing lighting device 120, 122 is provided which emits, in a privacy operational mode, a glary light beam 108 in an upward direction towards a ceiling 110 of the space 102. In the example of FIGS. 1a and 1b, two room dividing lighting devices 120, 122 are placed at the edges of the desk.

The glary light beams 108 are arranged in such a direction that, if the second person 114 or the third person 118, who are located outside the subspace 104, try to approach the first person 106 or try to enter the subspace 104, the eyes 112, 116 of the respective persons 114, 118 enter the glary light beam 108. This is shown in FIG. 1b. The third person 118 tries to approach the first person 106, for example, to start a conversation. When he comes close to or enters the subspace 104, the eyes 116 of the third person 118 receive light from the glary light beam 108. Glary light is unpleasant for people and, thus, the third person 118 is not happy with the glary light shining in his eyes 116. The third person 118 will not move closer to the first person 106 and, most probably, steps back such that his eyes 116 no longer receive the glary light from the glary light beam 108. Consequently, the third person 108 does not disturb the first person 106.

Thus, the separation of the subspace 104 from the space 102 is obtained by means of light beams which are emitted towards the ceiling 110. The second person 114 and the third person 118, when the light beam does not shine into their eyes 112, 116, can still see each other because the glary light beam 108 is not a barrier for other light transmitted along a direct line of sight between the eyes 112 of the second person 114 and the eyes 116 of the third person 118. Thus, for example, the second person 114 and the third person 118 can greet each other. Or, if the second person 114 is looking for the third person 118, he can still find the third person 118 without having to walk around the subspace 104. Thus, collaboration and visual contact between people in the space 102 is not limited by the fact that the room dividing lighting devices 120, 122 separate the subspace 104 from the space 102.

FIGS. 1a and 1b present cross-sections of the room dividing lighting devices 120, 122. In specific embodiments, the room dividing lighting devices 120, 122 may have an elongated shape which extends along the whole edge of the desk 121, which means that the drawn cross-section of the glary light beam 108 extends in a direction perpendicular to the plane of the drawn figures. In other embodiments the room dividing lighting device 120, 122 is a relatively small box which has a length smaller than the width of an upper surface of the desk 121 and which emits a glary light beam 108 that has, for example, the shape of a pyramid which is arranged upside-down.

The schematically presented mode of operation of FIGS. 1a and 1b is the privacy operational mode, which means that the room dividing lighting devices 120, 122 operate in a specific mode which results in the separation of the subspace from the space. In other words, in the privacy operational mode, the first person 106, who is present in the subspace, gets more privacy because the second person 114 and the third person 118 will not disturb him.

The room dividing lighting device 120, 122 may have a second function of lighting the space 102. The light of the glary light beam 108 is emitted towards the ceiling 110 and is most probably diffusely reflected by the ceiling 110. The diffusely reflected light provides pleasant lighting in the space 102, which assists the eyes of the first person 106 in doing his work, and allows everyone present in the space 102 (such as the second person 114 and the third person 118) to see each other well. If the room dividing lighting devices 120, 122 are used for lighting, fewer additional lighting systems must be installed in the space 102 and, therefore, costs for these additional lighting systems may be saved.

In an additional embodiment, the room dividing lighting devices 120, 122 comprise a sound cancelling means or sound masking means 124. The glary light beam 108 provides privacy to the first person 106, but the glary light beam 108 is not a barrier for sound. Thus, if the second person 114 and/or the third person 118 are talking with somebody, the first person 106 can still be disturbed by that sound. The sound masking means 124 transmits white noise into the subspace 104, which results in the first person 106 being less disturbed by the conversation of other people present in the space 102. Alternatively, the sound cancellation means is provided, which emits a specific sound which cancels other sound that reaches the ears of the first person 106.

The light sources of the room dividing lighting device emit a certain (light) flux. Flux is the total light output of the light sources. The light in the light beam has a certain luminance, which is the amount of light radiated by a visible light emitting surface of the room dividing lighting device in a certain direction. The luminance is related to the perceptual quality of “brightness” and via the brightness to the term “glare”. Glare is a disturbing or unpleasant brightness. Brightness and glare are related to the perception by humans of the specific luminance, and, thus, depend on the contrast between the ambient light conditions and the luminance of the light beam. The size of a light emitting surface and the distance to the light emitting surface also play a role. Small bright light sources at a large distance are called sparkling and, according to most people, are not perceived as glary—although this is highly subjective. If the average luminance of the light beam is larger than 10.000 Cd/m², the majority of the people consider the light of the light beam as glary. Under certain bright ambient lighting conditions, some people experience light of the light beam as glary light if the average luminance of the light beam is larger than 30.000 Cd/m². Average luminance is the average of the luminances of different light emission directions within the light beam. In an embodiment, the maximum luminance of light of the light beam is smaller than 200.000 Cd/m².

FIGS. 2a and 2b schematically show two embodiments of the use of the room dividing lighting device 204, 206 in a non-privacy operational mode. As shown in the two Figures, in the non-privacy operational mode the third person 118 can come close to the subspace or enter the subspace because he is not disturbed by glary light.

In FIG. 2a, the room dividing lighting devices 204, 206 are arranged to emit the glary light beam 202 in another direction such that the path of the eyes 116 of the third person 118 does not come within the glary light beam 202 when the third person comes close to or enters the subspace. Thus, the third person 118 can enter the subspace 104 and start, for example, a conversation with the first person 106. The glary light beam 202 is still emitted towards the ceiling, and, consequently, the lighting of the space 102 by means of the light of the room dividing lighting device 204, 206 is not interrupted.

In FIG. 2b, the room dividing lighting devices 252, 254 are arranged to emit no light in the non-privacy operation mode. Thus, anyone entering the subspace 104 is not disturbed by glary light and will, consequently, enter the subspace 104 to talk to or work together with the first person 106.

FIG. 3 schematically presents an alternative embodiment of the room dividing lighting device 308, 310. The room dividing lighting device 308, 310 comprises a base 306, 312 on which a light source 304, 314 is provided. At least in a privacy operation mode, the light source 304, 314 emits light into a transparent light guiding structure 302, 316. The transparent light guiding structure 302, 316 has light outcoupling structures such that a glary light beam 318 is emitted in an upward direction towards the ceiling 110 such that, if the second person 114 or the third person 118 comes too close to or enters the subspace 104, the eyes of the respective persons 114, 118 are exposed to the glary light beam 318. The schematically shown transparent light guiding structure 302, 316 emits light on a single side of the transparent light guide structure 302, 316. In other embodiments, the transparent light guiding structure emits light on more than one side of the transparent light guiding structure in an upward direction. A surface of the light guiding structure through which the light is emitted is a surface that extends substantially perpendicularly to the floor (or ceiling 110) of the space 102.

A line of sight between the second person 114 and the third person 118 is not obstructed because of the transparent character of the transparent light guiding structure 302, 316. An additional advantage of the transparent light guiding structures 302, 316 is that they form a barrier for sound. Thus, the first person 106 obtains additional privacy because he receives less sound. Further, the base 306, 312 of the room dividing lighting device 308, 310 may be non-transparent, but, in that case, the height of the base 306, 312 should be low enough such that a free line of sight between people present in the space (who sit at their desk or stay in the space 102) is not obstructed by the base 306, 312. In practical embodiments this means that the base 306, 312 should have a height which is smaller than 1.3 meter, or lower than 1 meter.

FIGS. 4a and 4b schematically show a cross-section of two embodiments of a room dividing lighting device 400, 450.

FIG. 4a presents a room dividing lighting device 400 which comprises a light redirection means being a lens 416. The room dividing lighting device 400 comprises a bottom plate 406 on which three light sources 408, 410, 412 are provided. On top of this is provided a lens 416 which redirects the light which it receives from the light sources such that, in the privacy operational mode, a glary light beam is formed. The center light source 410 is capable of emitting light of a relatively high intensity. In the privacy operational mode, the center light source 410 is switched on and glary light 402 is emitted in the glary light beam in an upward direction. In the non-privacy operational mode, the center light source 410 does not emit light, and the left and right light sources 408, 412 emit light at a lower flux (per light source) and the lens 416 redirects the light into two light beams with non-glary light 404, 414. The light flux emitted per light source 408, 412 is about half the light flux emitted by the center light source 410. In another embodiment, in the non-privacy operational mode, the center light source 410, together with the left and right light source 408, 412, emit light of an even lower light flux, for example, one third of the flux emitted by the center light source 410 in the privacy operational mode.

Consequently, in the non-privacy operational mode, the light beam emitted by the room dividing lighting device 400 is wider than the light beam emitted in the privacy operational mode. Also, the area of the lens 416 which emits light in the non-privacy operational mode is larger than the area of the lens which emits light in the privacy operational mode.

The room dividing lighting device further comprises a controller 418 which controls the room dividing lighting device to operate in the privacy or non-privacy operational mode. The controller 418 receives, for example, user input in which the user indicates whether he wants to have privacy or not. Alternatively, the controller 418 receives sensor input which allows the controller to detect the presence of a person in the sub-space or even to detect the type of activity that is executed in the sub-space to control the light sources accordingly. The controller 418 further controls the intensity of the light to be emitted by each one of the individual light sources 408, 410, 412.

The lens 416 may be manufactured of glass or a transparent synthetic material, such as, for example, polycarbonate (on which a protection layer is provided to prevent scratches on the relatively soft polycarbonate layer) or Polymethylmethacrylate (PMMA).

The light sources 408, 410, 412 are, for example, Light Emitting Diodes (LEDs), but embodiments of the light sources 408, 410, 412 are not limited to LEDs. Other embodiments of the light sources 408, 410, 412 are Organic Light Emitting Diodes, fluorescent light tubes, or traditional incandescent lamps.

FIG. 4b schematically presents a cross-section of a room dividing lighting device 450 which comprises a reflector 454 as a light redirection means. The room dividing lighting device comprises a bottom plate 406 on which a light source 456 is provided. The light of the light source 456 is received by the reflector 454 which redirects the angular light emission directions of the light rays towards a relatively narrow glary light beam 452 in an upward direction (in the privacy operational mode). The reflector 454 is movable 458 in an upward and downward direction. By changing the relative distance between the light source 456 and the reflector 454, the light beam may be made wider or narrower, depending on the operational mode in which the room dividing lighting device has to operate. If the emitted light beam is wider, the light is less glary because at least the average luminance decreases. People who want to enter the subspace face no limitations in doing so. In another embodiment, the light source 456 does not emit light when the room dividing lighting device operates in the non-privacy operational mode. The controlling of the position of the reflector 458 with respect to the position of the light source 456 may be performed by a controller (not shown) which provides an actuator with a control signal indicating the required position of the reflector 454 with respect to the light source 456. The reflector 454 may be made of a reflective metal or a synthetic material on which a reflecting coating is provided.

Alternatively (not shown), a diffuser is arranged at the light exit window of the reflector 454 such that a wider light beam is emitted having a reduced luminance.

FIGS. 5a and 5b schematically show cross-sections of two other embodiments of a room dividing lighting device 500, 550 comprising a collimator 502, 552, 558.

FIG. 5a presents a room dividing lighting device 500 which comprises a bottom plate 406 on to which a collimator 502 is attached. The collimator 502 is a solid structure of a light transmitting material. Light which is received from a light source 504 is guided through the transparent material. If light impinges on one of the side walls 503 of the collimator, the impinging light is subject to total internal reflection, and therefore the side walls 503 act as a reflecting surface for the guided light. At a light exit window 501 of the collimator, light impinges at relatively small angles (measured with respect to a normal to the light exit window 501) at the interface between the solid transparent material and the ambient air, which results in the outcoupling of the guided light. Thus, the collimator 502 creates a collimated light beam which may comprise glary light (depending on the emitted light intensity).

The light source 504 is movable 506 in an upward and downward direction (relative to a light input window of the collimator). Depending on the relative position, the light beam that is emitted through the light exit window 501 of the collimator is relatively narrow or slightly wider. In a privacy operational mode, the relative position of the light source 504 is controlled to be such a relative position that the emitted light beam is relatively narrow to obtain a high flux of light in the emitted light beam, which means that the light is experienced by humans as glary light. In a non-privacy operational mode, the relative position of the light source 504 is controlled to be such a relative position that the emitted light beam is relatively wide, such that the flux of light in the emitted light beam is low, which means that the light is not experienced as glary light by humans. Further, in the non-privacy operational mode, the light intensity emitted by the light source 504 may be controlled to be lower. The controlling of the relative position and/or the controlling of the emitted light intensity is performed by a controller (not shown).

FIG. 5b presents a room dividing lighting device 550 which comprises two light sources 554, 556 which are each provided with a respective collimator 552, 558. A border of the subspace 104 is schematically indicated. If the room dividing lighting device is operated in the privacy operational mode, a first light source 554 emits light and a first collimator 552 emits a light beam comprising glary light in a direction away from the subspace 104 such that persons who come too close or try to enter the subspace will have their eyes exposed to the glary light. When the glary light shines into their eyes, these persons return and do not enter the subspace. If the room dividing lighting device is operated in the non-privacy operational mode, a second light source 556 emits light and a second collimator 558 emits a light beam inwards in a subspace and persons who try to come close to or enter the subspace do not pass the glary light beam, which is uncomfortable, unpleasant, and disturbing to their eyes.

FIG. 6a schematically shows an embodiment of a room dividing lighting device 600 which emits light along a larger surface in a non-privacy operational mode. On a bottom plate 406 of the room dividing lighting device 600 are provided light source 608, 612, 614 and on top of each of them a light redirection means 606, 610, 618, respectively, is provided. If the room dividing lighting device 600 operates in a privacy operational mode, only one of the light sources emits light at a relatively high intensity. For example, in the privacy operational mode, light source 612 emits a high intensity of light such that a glary light beam 602 is obtained. In the non-privacy operational mode, two light sources 608, 614 emit light at a lower intensity and therefore two light beams 604, 616 with non-glary light are emitted in the upward direction. If, instead of one light source 612, two light sources 608, 614 emit light, the light emission surface of the room dividing lighting device 600 increases, which results in a less glary light emission. In another embodiment, in the non-privacy operational mode, light source 612 also emits light together with the two other light sources 608, 614, but they all emit light at a much lower light intensity than the middle light source 612 emits in the privacy operational mode.

FIG. 6a shows a cross-section taken on the line A-A′ of the room dividing lighting device 600 of FIG. 6b. FIG. 6b shows a three dimensional view of the embodiment of the room dividing lighting device 600 of FIG. 6a. A plurality of light sources with light redirection means are arranged in an array. The light sources are controlled per row R1, R2, R3 of the array, in line with the above-discussed controlling in the context of FIG. 6a. For example, in the privacy operational mode, the light sources in the middle row R2 emit light of a relatively high intensity to create an elongated light beam of V shape. In the non-privacy operational mode, a plurality of rows R1, R2, R3 of light sources are configured to emit light (with a lower light intensity per light source).

In another embodiment (not shown), instead of rows of light sources R1, R2, R3, three light sources of an elongated shape (in the direction of the rows R1, R2, R3 of FIG. 6b) and elongated lenses are provided.

It is to be noted that FIGS. 4a, 4b, 5a and 5b all present a cross-section of a room dividing lighting device and that, in line with the discussion of FIGS. 6a and 6b, the room dividing lighting devices may have an elongated shape and that a plurality of light sources together with their light redirection means may be arranged in rows and that all light sources in one row are controlled simultaneously. Alternatively, the light sources and the light redirection means have an elongated shape.

FIGS. 7a and 7b schematically show two embodiments of a room dividing lighting device 700, 750 comprising a transparent light guiding structure 702, 762, 764. As discussed in the context of FIG. 3, the room dividing lighting device may be provided with a transparent light guiding structure which also forms a barrier for sound transmission between the space and the subspace.

In FIG. 7a the room dividing lighting device 700 comprises a base 706 on which a light source 704 is provided. The light source 704 emits light towards a light input window 703 of a transparent light guiding structure 702. The light which enters the transparent light guiding structure 702 is guided in an upward direction. The light guiding structure 702 comprises light outcoupling structures 708, and if the guided light impinges on a light outcoupling structure 708, the light is outcoupled in a specific direction such that it becomes part of an upward emitted light beam which comprises, at least in the privacy operational mode, glary light. In a non-privacy operational mode, the intensity of the light may be reduced to prevent the emission of glary light. One of the outcoupled light rays 710 is schematically drawn in FIG. 7a.

In FIG. 7b the room dividing lighting device 750 comprises two light sources 756, 758 provided on a base 706 and it further comprises two transparent light guiding structures 762, 764. Light emitted by a first light source 756 is emitted into a first transparent light guiding structure 762 which comprises light outcoupling structures 754 at one of its surfaces to outcouple light so as to obtain an upward oriented light beam which may, depending on the operational mode, comprise glary light. One of the (outcoupled) light rays 752 originating from the first light source 756 is schematically indicated in FIG. 7a. Light emitted by a second light source 758 is received by the second transparent light guiding structure 764 which guides the received light in an upward direction. The second light guiding structure 764 comprises light outcoupling structures at a surface which faces away from the first light guiding structure 762. The light outcoupling structures are arranged on either side of the room dividing lighting device 750. One of the light rays 760 emitted by the second light source 758 is schematically drawn in FIG. 7b.

Further, in FIG. 7b the border of the subspace 104 is schematically indicated with a dashed line. In a privacy operational mode, at least light source 756 emits light at a relatively high light intensity such that a light beam comprising glary light is obtained on the left side of the room dividing lighting device. The light beam with glary light prevents that people come close to or enter the subspace 104. In a non-privacy operational mode, the first light source 756 does not emit light, or emits light with lower intensity, and the second light source 758 compensates for the reduction of the light emission by the first light source 756. Thus, the total light emission remains the same, which is especially advantageous if the room dividing lighting device 750 is also part of the lighting system of the space in which it is provided. If the second light source 758 emits light, the upward emitted light beam is not emitted into the direction of the eyes of persons who try to come close to the subspace 104, and therefore it does not prevent them from entering the subspace 104.

The transparent light guiding structures 702, 762, 764 may be manufactured of glass or of a transparent synthetic material, such as, for example, Polymethylmethacrylate (PMMA). The transparent synthetic material may be coated with an anti-scratch coating to protect the surface of the transparent light guiding structures 702, 762, 764. The outcoupling structures may be protrusions or recesses in the surface of the transparent light guiding structures 702, 762, 764. The shape of the light outcoupling structures is configured to couple out light in an upward direction at a relatively small light emission angle with respect to the surface through which the light is outcoupled. The recesses and protrusions may be manufactured using known technologies, like printing additional material for obtaining specific protrusions, locally etching away some material, or sawing grooves of a specific shape into the surface of the transparent light guiding structures 702, 762, 764. If the transparent light guiding structures 702, 762, 764 are manufactured of a synthetic material, they may, for example, be manufactured by injection molding. The mold cavity may have the shape of the transparent light guiding structures 702, 762, 764, including the protrusions and recesses.

FIGS. 8 to 10 present angular light emission profiles of room dividing lighting devices comprising a transparent light guiding structure 802, 902, and 1002, respectively.

In FIG. 8, a specific transparent light guiding structure 802 is presented on the left-hand side together with the associated chart 810 on the right-hand side. If the light source 804 emits light into the transparent light guiding structure 802, a light beam is emitted in an upward direction which has a specific angular light intensity distribution that is presented in the chart 810. In the chart 810, the x-axis represents the angle with respect to a central axis of the emitted light beam. The y-axis represents the normalized light intensity. Along line A-A′, at different angles α the light intensity has a normalized intensity as presented by line 806. Along a plane perpendicular to the plane of the Figure and along the central axis of the emitted light beam, the light intensity at angles β with respect to the central axis is presented with line 808. It shows that the emitted light beam comprises two sub-beams which are relatively narrow (−40 to −10 degrees and 10 to 40 degrees) along line A-A′ and that the maximum intensity in the beam is relatively high. Along a plane perpendicular to the plane of the Figure (through the central axis at α=0) the light emission is relatively low.

In FIG. 9, chart 910 represents the angular light intensity distribution of transparent light guiding structure 902. Along line A-A′ the distribution 904 is obtained, which is also relatively narrow (−20 to 5 degrees) and which has a relatively high intensity peak. In a direction perpendicular to the plane of the figure along a plane through the central axis of the light beam (through the central axis at α=0), the light emission distribution 906 is obtained. This light emission distribution 906 has a relatively high value, because at α=0 the emitted light intensity is also relatively high.

In chart 1010, the respective light intensity distributions 1004 and 1006 along line A-A′ and along a line perpendicular to the plane of the transparent light guiding structure 1002 of FIG. 10 (and through the central axis of the light beam at α=0) are presented. It can be seen that the transparent light guiding structure 1002 is capable of emitting a relatively intense and narrow light beam on its left side.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A room dividing lighting device for separating a subspace from a space to prevent a person from coming close to or entering the subspace in a privacy operational mode of the room dividing lighting device, the room dividing lighting device being configured to operate in a privacy operational mode or in a non-privacy operational mode, the room dividing lighting device comprising a light emitting unit for emitting light in an upward direction and being configured to emit, in a privacy operational mode, glary light in a light beam for hindering the person entering the light beam or crossing the light beam with his eyes and to emit, in the non-privacy mode, non-glary light in the upward direction,
the light emitting unit comprising at least one light source and a light redirection unit receiving light from the at least one light source and being configured for redirecting, at least in the privacy operational mode, the received light into the light beam.

2. (canceled)

3. A room dividing lighting device according to claim 1, further comprising a base for supporting the light emitting unit, wherein a height of the base is configured for not obstructing a direct line of sight between people who are present in the space and who sit on a chair or who stay upright.

4. A room dividing lighting device according to claim 1, wherein the light redirection unit comprises a transparent light guiding structure, the transparent light guiding structure receiving the light from the at least one light source, and the transparent light guiding structure comprising light outcoupling structures for outcoupling light being guided within the transparent light guiding structure in the upward direction.

5. A room dividing lighting device according to claim 4, wherein the light outcoupling structures are recesses and/or protrusions in a light emitting surface of the transparent light guiding structure.

6. A room dividing lighting device according to claim 1, wherein the light redirection unit is a lens, a collimator or a reflector.

7. (canceled)

8. A room dividing lighting device according to claim 1, wherein the light emitting unit is configured for emitting, in the non-privacy operational mode, the light beam in another direction which does not cross the path of the eyes of the person who tries to come close to, or who tries to enter, the subspace.

9. (canceled)

10. A room dividing lighting device according to claim 1, wherein the one or more light sources of the light emitting unit are configured to emit, in the non-privacy operational mode, at a reduced flux compared to the privacy operational mode.

11. A room dividing lighting device according to claim 1, wherein the light emitting unit is configured to emit, in the non-privacy operational mode, light along a first light emitting surface, and to emit, in the privacy operational mode, light along a second light emitting surface, the second light emitting surface being smaller than the first light emitting surface.

12. A room dividing lighting device according to claim 1, wherein the light emitting unit is configured to emit, in the non-privacy operational mode, a wider light beam than the light beam emitted in the privacy operational mode.

13. A room dividing lighting device according to claim 6, wherein
the lens, the collimator or the reflector have a first relative position with respect to one or more light sources that emit light in the privacy operational mode,
the lens, the collimator or the reflector have a second relative position with respect to one or more light sources that emit light in the non-privacy operational mode, and
the first relative position is different from the second relative position.

14. Use of a room dividing lighting device according to claim 1 for separating a subspace from a space to prevent a person from coming close to or entering the subspace if the room dividing lighting device operates in a privacy operational mode.

15. Method of installing a room dividing lighting device in a space for separating a subspace from the space to prevent a person from coming close to or entering the subspace if the room dividing lighting device operates in a privacy operational mode, the method comprising the steps of:
providing the room dividing lighting device configured to operate in a privacy operational mode or in a non-privacy operational mode,
emitting light in an upward direction by the room dividing lighting device comprising a light emitting unit,
emitting, in the privacy operational mode, glary light in a light beam for hindering the person entering the light beam or crossing the light beam with his eyes and to emit, in the non-privacy mode, non-glary light in the upward direction, and
installing the room dividing lighting device on or close to a border of the subspace to make the light beam propagate in the upward direction on or close to the border of the subspace.

16. A room dividing lighting device according to claim 1, wherein, in the privacy operational mode, at least at light emission angles smaller than 20 degrees with respect to a central axis of the light beam, glary light is emitted by the light emitting means.

17. A room dividing lighting device according to claim 1, wherein a maximum light emission angle with respect to a central axis of the light beam is smaller than 45 degrees.

18. A room dividing lighting device according to claim 1, wherein in the privacy operational mode the light beam having an average luminance of 10.000 Cd/m2 or more, luminance being the amount of light radiated by a visible light emitting surface in a certain direction and the average luminance being an average of luminances of light emission directions of the light beam, the light emitting unit comprising at least one light source and a light redirection unit receiving light from the at least one light source and being configured for redirecting, at least in the privacy operational mode, the received light into the light beam.

19. The method according to claim 1,wherein in the privacy operational mode the light beam having an average luminance of 10.000 Cd/m2 or more, luminance being the amount of light radiated by a visible light emitting surface in a certain direction and the average luminance being an average of luminances of light emission directions of the light beam, the light emitting means comprising at least one light source and a light redirection means receiving light from the at least one light source and being configured for redirecting, at least in the privacy operational mode, the received light into the light beam
